(19) United States
(12) Patent Application Publication
(10) Pub. No.: US 2019/0279154 A1
(43) Pub. Date: Sep. 12, 2019

(54) SERVER DEVICE AND DELIVERY SYSTEM

(71) Applicant: TOYOTA JIDOSHA KABUSHIKI KAISHA, Toyota-shi (JP)

(72) Inventors: Etsuko Nakajima, Nagoya-shi (JP); Naoki Uenoyama, Nisshin-shi (JP); Junya Masui, Nagoya-shi (JP); Akira Hoshino, Nagoya-shi (JP); Hideo Hasegawa, Nagoya-shi (JP); Keiko Nakano, Kawasaki-shi (JP)

(73) Assignee: TOYOTA JIDOSHA KABUSHIKI KAISHA, Toyota-shi (JP)

(21) Appl. No.: 16/281,286

(22) Filed: Feb. 21, 2019

(30) Foreign Application Priority Data
Mar. 12, 2018 (JP) 2018-043986

(51) Int. Cl. G06Q 10/08; H04W 12/04; G08B 21/18

(52) U.S. Cl. CPC G06Q 10/0838; G08B 21/18; H04W 12/04031

(57) ABSTRACT

A server device is configured to determine whether or not a package is able to be stored in a predetermined region of a storage device, the predetermined region being lockable and unlockable. The server device includes a processor configured to: acquire storage device information that is information about a size of the predetermined region in the storage device; acquire package information that is information about a size of the package to be stored in the predetermined region; and perform a determination to determine whether or not the package is able to be stored in the predetermined region, based on the package information and the storage device information.

### INCORPORATION BY REFERENCE

The disclosure of Japanese Patent Application No. 2018-043986 filed on Mar. 12, 2018 including the specification, drawings and abstract is incorporated herein by reference in its entirety.

### BACKGROUND

### 1. Technical Field

The disclosure relates to a server device a system for storing a package by use of a storage device.

### 2. Description of Related Art

A technique for delivering and receiving a delivery package by use of a trunk of a package-receiving vehicle designated by a recipient as a delivery destination has been proposed (e.g., see Japanese Unexamined Patent Application Publication No. 2006-206225 (JP 2006-206225 A)). With the use of the technique, in a case where the recipient designates his/her own vehicle as a delivery destination, even if the recipient is absent, the recipient can receive a delivery package without setting up a home locker or the like to receive the delivery package.

### SUMMARY

In the meantime, a space inside a parking vehicle is limited, so a package to be delivered may not be able to be stored in the space. For example, depending on a size of the package, the package cannot be stored in a trunk of the vehicle, so that the package may be returned to depot.

The disclosure provides a technique to determine whether or not temporary storage of a package is performable appropriately by use of a storage device.

A first aspect of the present disclosure relates to a server device configured to determine whether or not a package is able to be stored in a predetermined region of a storage device, the predetermined region being lockable and unlockable, the server device comprising a processor configured to: acquire storage device information that is information about a size of the predetermined region in the storage device; acquire package information that is information about a size of the package to be stored in the predetermined region; and perform a determination to determine whether or not the package is able to be stored in the predetermined region, based on the package information and the storage device information.

The predetermined region is a lockable and unlockable region of a facility or equipment in which a package is storable, and examples of the predetermined region include a vehicle cabin, a trunk, and the like of an automobile. However, the predetermined region is not limited to this. The following deals with an automobile as an example, but the disclosure is also applicable to facilities or equipment other than the automobile. The storage device information is information about the size of the predetermined region provided in the storage device, and in a case where the storage device is a vehicle, the storage device information is information about a size of a vehicle cabin or a trunk of the vehicle, for example. Note that the storage device information may be information other than the information indicative of size, provided that the storage device information is information about the size of the predetermined region. The package information is information about the size of the package to be stored in the vehicle. The package information may include information indicative of magnitudes of three sides of the package, and the like, for example. Further, the processor determines whether or not the package is storable appropriately, based on the storage device information and the package information corresponding to the package to be stored in the vehicle. For example, in a case where a size of at least any of the three sides of the package exceeds the size of the predetermined region, it is determined that the package is not storable appropriately. With such a configuration, it is possible to prevent such a trouble that, after the storage device is unlocked, the package is found not to be storable in the storage device.

In the above aspect, the processor may be configured to, when the processor determines that the package is able to be stored in the predetermined region, transmit key information to a portable terminal possessed by a user who intends to store the package in the predetermined region, the key information being used for unlocking the predetermined region.

The key information is electronic data to unlock the predetermined region. For example, a portable terminal transfers the key information to the storage device so as to perform authentication, so that the region in which the package is to be stored is locked and unlocked. The key information is transmitted only when it is determined that storage of the package is able to be appropriately performed, so that a trouble to be caused after a delivery carrier starts on delivery can be avoided.

In the above aspect, the processor may be configured to perform notification to a predetermined device when the processor determines that the package is not able to be stored in the predetermined region.

When it is determined that storage of the package is not able to be appropriately performed, the notification may be performed to a portable terminal possessed by a delivery carrier or the like, a server device managed by a delivery company or the like, a portable terminal possessed by a recipient, and so on, for example. With such a configuration, a receipt method or delivery date and time can be changed quickly.

In the above first aspect, the processor may be configured to acquire, as the storage device information from the storage device, a result of sensing the size of the predetermined region.

In a case where a package has been already stored in the storage device, a usable space decreases, so that a package to arrive later might not be storable. In view of this, whether the package is storable or not may be determined based on a result of sensing the usable space. The sensing may be performed by use of a sensor configured to acquire a physical amount such as a distance or may be performed by analyzing a result of capturing image of the inside of the device.

In the above first aspect, the processor may be configured to: acquire a history about package storage of the storage device; and perform the determination further based on the history.

With such a configuration, in a case where a plurality of packages is to be delivered, whether the packages are storable or not can be determined appropriately.

In the above aspect, the processor may be configured to: acquire receipt information from a recipient, the receipt information indicating that the recipient has taken out the package from the storage device; and perform the determination further based on the receipt information.

By acquiring information indicating that the package has been taken out from the storage device, it is possible to specify a package currently present in the storage device. That is, in a case where a plurality of packages is to be delivered, whether the packages are storable or not can be determined more accurately.

In the above first aspect, the storage device may be a vehicle, and the processor may be configured to acquire the storage device information defined for each vehicle type.

As such, in a case where the storage device is a vehicle, it is possible to easily estimate a size of the predetermine region per vehicle type.

A second aspect of the present disclosure relates to a delivery system comprising: a storage device configured to be locked and unlocked based on authentication information acquired from a portable terminal; and a server device configured to determine whether or not a package is able to be stored in a predetermined region of the storage device, wherein: the storage device includes a transmitter configured to transmit storage device information that is information about a size of the predetermined region in the storage device; the server device includes a receiver configured to acquire the storage device information, and a processor; and the processor is configured to acquire package information that is information about a size of the package to be stored in the predetermined region, and determine whether or not the package is able to be stored in the predetermined region, based on the package information and the storage device information.

Note that the disclosure can be specified as a server device including at least some of the above features. Further, the disclosure can be specified as a delivery system including the server device. The above features can be combined freely as far as they are not technically inconsistent with each other.

With the disclosure, it is possible to determine whether or not temporary storage of a package is performable appropriately by use of a storage device.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a system schematic diagram of a delivery system according to a first embodiment;

FIG. 2 is a block diagram schematically illustrating an example of constituents of the delivery system;

FIG. 3 illustrates examples of vehicle information and package information;

FIG. 4 is a view to describe a data flow in the first embodiment;

FIG. 5 is a view to describe a data flow in the first embodiment;

FIG. 6 is a view illustrating details of a process in step S12;

FIG. 7 is a view to describe a preexisting package in a vehicle cabin; and

FIG. 8 is a view to describe preexisting package information in a second embodiment.

### DETAILED DESCRIPTION OF EMBODIMENTS

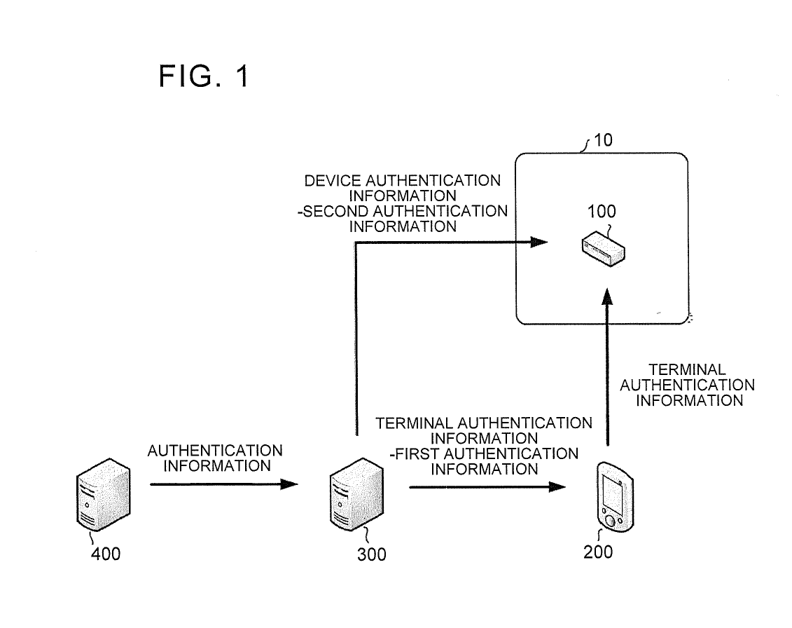

A summary of a delivery system according to a first embodiment of the disclosure will be described with reference to FIG. 1. The delivery system according to the present embodiment includes a locking/unlocking device 100, a portable terminal 200, a delivery management server 300, and a key management server 400. In the delivery system according to the present embodiment, the locking/unlocking device 100 provided in a vehicle 10 wirelessly communicates with the portable terminal 200 provided outside the vehicle 10, so as to lock and unlock the vehicle 10 based on a result of the communication. That is, a user of the system can lock and unlock the vehicle 10 only by use of the portable terminal 200 without the use of a physical key. In the delivery system according to the present embodiment, a delivery carrier who delivers a package possesses the portable terminal 200 and can lock and unlock the vehicle 10 designated by a recipient, as needed. Hereby, the vehicle 10 can be used as a delivery destination (a home delivery box or a delivery locker).

The key management server 400 is a server device configured to issue information (authentication information) for the locking/unlocking device 100 to authenticate the portable terminal 200. The key management server 400 issues first authentication information to the portable terminal 200 via the delivery management server 300 and also issues second authentication information to the locking/unlocking device 100 via the delivery management server 300. The locking/unlocking device 100 verifies these pieces of authentication information with each other so as to authenticate that the portable terminal 200 is rightful.

The delivery management server 300 is a server device configured to manage delivery states of packages and a plurality of portable terminals 200 possessed by delivery carriers who deliver the packages. Note that, in FIG. 1, only one portable terminal 200 and only one vehicle 10 are illustrated, but the delivery management server 300 may manage a plurality of portable terminals 200. Further, the portable terminal 200 may access a plurality of vehicles 10.

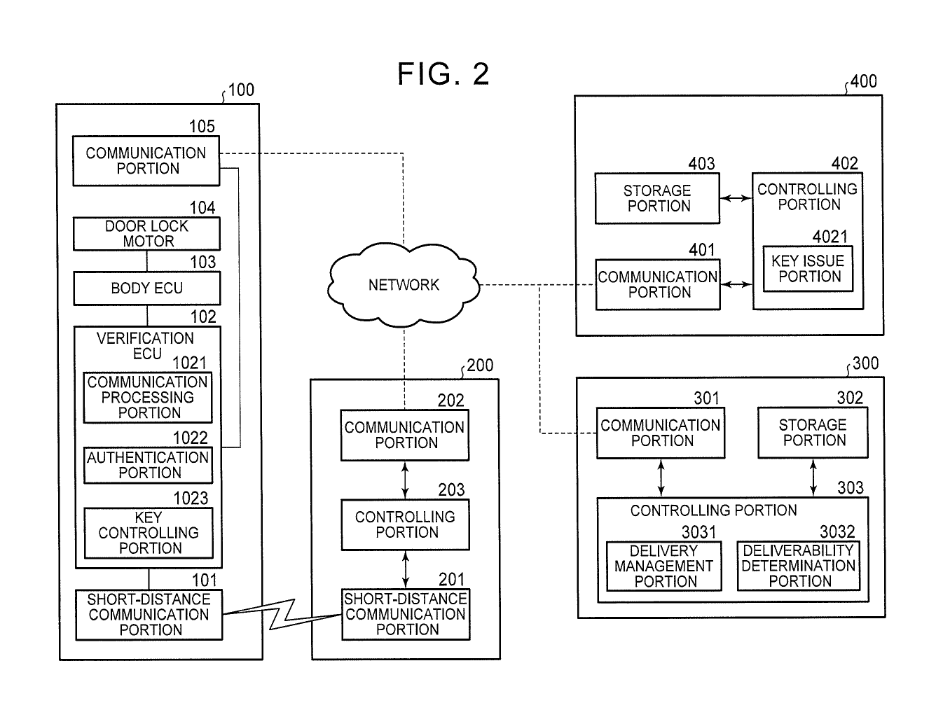

The following describes constituents of the system in detail. FIG. 2 is a block diagram schematically illustrating one example of configurations of the locking/unlocking device 100, the portable terminal 200, the delivery management server 300, and the key management server 400. Among them, the locking/unlocking device 100 is provided in the vehicle 10 as a target for locking/unlocking (locking and unlocking).

The locking/unlocking device 100 is a device configured to lock and unlock a door of the vehicle. More specifically, the door of the vehicle 10 is locked and unlocked in response to a locking signal and an unlocking signal transmitted from an electronic key (a portable) possessed by a user of the vehicle via a high-frequency radio wave. In the present embodiment, the locking/unlocking device 100 has a function of locking and unlocking the door based on a result of the communication with the portable terminal 200 in addition to the above function.

The locking/unlocking device 100 includes a short-distance communication portion 101, a verification ECU 102, a body ECU 103, a door lock motor 104, and a communication portion 105. The locking/unlocking device 100 works by electric power supplied from an auxiliary battery (not shown) provided in the vehicle 10. Note that, in this example, means that communicates with the electronic key is not illustrated.

The short-distance communication portion 101 is a module configured to communicate with the portable terminal 200 possessed by the user. The short-distance communication portion 101 performs communication in a short distance (to such a degree that communication can be performed between the inside of a vehicle cabin and the outside of the vehicle cabin) by use of a predetermined wireless communication standard.

In the present embodiment, the short-distance communication portion 101 performs data communication by the Bluetooth (registered trademark) Low Energy protocol (hereinafter referred to as BLE). The BLE is a low power telecommunications standard by Bluetooth and has a feature to start communication immediately by detecting a counterpart without requiring pairing between devices. Note that the present embodiment exemplifies the BLE, but other wireless communication standards are also usable. For example, a near field communication (NFC), an ultra-wide band (UWB), Wi-Fi (registered trademark), and the like can be used.

The verification ECU 102 is a computer configured to perform short-distance wireless communication with the portable terminal 200 via the short-distance communication portion 101 and to perform a control to authenticate the portable terminal 200 and a control to lock and unlock the door of the vehicle 10 based on the authentication result. The verification ECU 102 is constituted by a microcomputer, for example. Note that, in the following description, the locking signal and the unlocking signal are collectively referred to as a locking/unlocking signal. The word “locking/unlocking signal” indicates at least either one of the locking signal and the unlocking signal.

The verification ECU 102 includes a communication processing portion 1021, an authentication portion 1022, and a key controlling portion 1023 as functional modules. Each of the functional modules may be implemented by executing a program stored in storage means such as a read only memory (ROM) by a central processing unit (CPU) (they are not illustrated herein).

The communication processing portion 1021 processes communication with the portable terminal 200 performed via the short-distance communication portion 101. More specifically, the communication processing portion 1021 receives a locking request or an unlocking request (hereinafter collectively referred to as a locking/unlocking request) from the portable terminal 200, and in response to the request thus received, the communication processing portion 1021 generates a locking/unlocking signal. Note that the locking/unlocking signal thus generated is stored temporarily, and at the timing when the authentication portion 1022 (described later) successfully authenticates the portable terminal 200, the locking/unlocking signal is output.

The authentication portion 1022 authenticates the portable terminal 200 based on authentication information included in the locking/unlocking request transmitted from the portable terminal 200. More specifically, the authentication portion 1022 compares authentication information stored in storage means (not shown) with the authentication information transmitted from the portable terminal 200, and when they correspond to each other, the authentication portion 1022 determines that the authentication is successful. When the pieces of authentication information do not correspond to each other, the authentication portion 1022 determines that the authentication is failure. When the authentication portion 1022 successfully authenticates the portable terminal 200, the locking/unlocking signal generated by the communication processing portion 1021 is transmitted to the key controlling portion 1023 (described later). Note that a method of the authentication performed by the authentication portion 1022 may be a method to verify sameness by simply comparing the pieces of authentication information with each other or may be a method using asymmetric cryptography. That “the pieces of authentication information correspond to each other” may indicate that two pieces of authentication information are verified to correspond to each other, and they may not be necessarily identical with each other. Hereinafter, the authentication information stored in the locking/unlocking device 100 is referred to as device authentication information, and the authentication information transmitted from the portable terminal 200 is referred to as terminal authentication information if necessary in view of the description. Note that, when it is not necessary to distinguish those pieces of authentication information from each other, they are just referred to as authentication information. Note that the device authentication information stored in the authentication portion 1022 is generated by the key management server 400 (described later), and the device authentication information is received and stored via a network.

The key controlling portion 1023 transmits an unlock command or a lock command to the body ECU 103 (described later) based on a result of the authentication performed by the authentication portion 1022. The signal is transmitted via an in-vehicle network such as a controller area network (CAN).

The body ECU 103 is a computer configured to perform a body control of the vehicle. The body ECU 103 has a function to perform locking and unlocking of the door of the vehicle by controlling the door lock motor 104 (described later) based on the lock command or the unlock command received from the key controlling portion 1023. Note that the body ECU 103 may further have functions to control components related to a vehicle body, e.g., power window control, seat adjustment, theft prevention, seat belt control, headlight control, and so on.

The door lock motor 104 is an actuator configured to lock and unlock the door of the vehicle 10 (including a trunk, in addition to doors for occupant getting on/off the vehicle and a rear gate). The door lock motor 104 works based on a signal transmitted from the body ECU 103.

The communication portion 105 is a communication interface configured to connect the locking/unlocking device 100 to a network. In the present embodiment, the communication portion 105 can communicate with other devices via a network by use of a mobile communication service such as 3G or LTE.

Descriptions are now made of the portable terminal 200. The portable terminal 200 is a small computer such as a smartphone, a mobile phone, a tablet terminal, a personal information terminal, a notebook computer, and a wearable computer (a smart watch and the like), for example. The portable terminal 200 is constituted by a short-distance communication portion 201, a communication portion 202, and a controlling portion 203.

The short-distance communication portion 201 is means that communicates with the locking/unlocking device 100 by the same telecommunications standard as the short-distance communication portion 101. The communication portion 202 is a communication interface configured to perform network connection similar to the communication portion 105.

The controlling portion 203 is means that manages a control of the portable terminal 200. The controlling portion 203 performs, for example, a process of generating a locking/unlocking request, a process of acquiring the terminal authentication information described above, a process of transmitting the locking/unlocking request and the terminal authentication information to the locking/unlocking device 100, and so on. The controlling portion 203 is constituted by a microcomputer, for example. The controlling portion 203 may implement these functions by causing a CPU to perform programs stored in storage means (ROM and the like) (they are not illustrated herein).

The controlling portion 203 is connected to an input/output portion (not shown) configured to perform interaction with the user. The input/output portion is constituted by a touch panel, its control means, a liquid crystal display, and its control means, for example. In the present embodiment, the touch panel and the liquid crystal display are constituted by one touch panel display.

The controlling portion 203 displays an operation screen via the input/output portion and generates an unlocking request or a locking request based on the operation performed by the user. For example, the controlling portion 203 outputs an icon for unlocking, an icon for locking, and the like to the touch panel display, and generates an unlocking request or a locking request based on the operation performed by the user. Note that the operation performed by the user is not limited to an operation performed via the touch panel display. For example, the operation may be an operation performed via a hardware switch or the like.

Further, the controlling portion 203 performs a process of acquiring terminal authentication information. In the present embodiment, the terminal authentication information is generated in the key management server 400 (described later) and is transmitted to the portable terminal 200 via the delivery management server 300 (described later). Note that, when the portable terminal 200 does not have the terminal authentication information, a lock operation and an unlock operation from the operation screen cannot be performed. The terminal authentication information acquired by the portable terminal 200 may be an unchangeable key or may be a one-time key. In either case, device authentication information corresponding to the terminal authentication information is stored in the locking/unlocking device 100 in advance.

Descriptions are now made of the delivery management server 300. The delivery management server 300 is a server device configured to manage packages to be delivered and the portable terminals 200 possessed by a plurality of delivery carriers. Information about a target package is stored in the delivery management server 300. In a case where the vehicle 10 is designated as its delivery place, the delivery management server 300 acquires, from the key management server 400, terminal authentication information to lock and unlock the vehicle 10 in which the package is to be stored and transfers the terminal authentication information to the portable terminal 200. This process is performed before the delivery carrier starts on delivery.

Further, the delivery management server 300 acquires, from the key management server 400, device authentication information corresponding to the vehicle 10 (the locking/unlocking device 100) and transfers the device authentication information to the locking/unlocking device 100 (the verification ECU 102). This process may be performed for every delivery of a package or may be performed at a timing irrelevant with delivery of a package. In the present embodiment, the device authentication information is acquired at the time of setup of the system and is transferred to the locking/unlocking device 100.

The delivery management server 300 is constituted by a communication portion 301, a storage portion 302, and a controlling portion 303. The communication portion 301 is a communication interface configured to perform network connection similar to the communication portion 105.

The storage portion 302 is means in which information is stored and is constituted by a storage medium such as a RAM, a magnetic disk, or a flash memory. Information to deliver a package to a vehicle is stored in the storage portion 302.

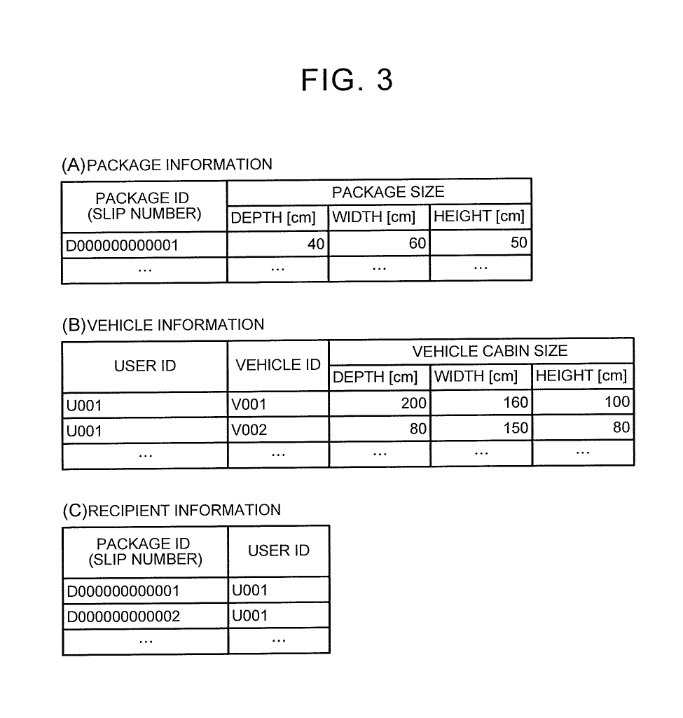

With reference to FIG. 3, the following describes the information for delivering a package to a vehicle. In the present embodiment, three types of information, i.e., package information, vehicle information, and recipient information are stored in the storage portion 302. The package information is information in which an identifier of a package (hereinafter referred to as a package ID) is associated with information about a size of the package. In the present embodiment, as the information about the size of the package, a depth size, a width size, and a height are stored. Every time delivery of a package occurs, the package information is updated by a delivery company. Note that the package information may be updated based on information input by a sender of a package.

The vehicle information is information (an example of “storage device information” in the disclosure) in which an identifier of a recipient (hereinafter referred to as a user ID), an identifier of the vehicle 10 as a delivery destination of a package (hereinafter referred to as a vehicle ID), and information about a size of a vehicle cabin of the vehicle are associated with each other. Herein, the vehicle cabin indicates a region (e.g., a ride space or a trunk) where a package is storable inside the vehicle. In the present embodiment, a depth size, a width size, and a height of a space where a package can be placed are stored. The vehicle information is registered by a recipient when the recipient starts to use the service. That the vehicle information is registered in the storage portion 302 indicates that delivery of a package to the vehicle is permitted. Note that, in a case where information in which a vehicle type of the vehicle 10 is associated with a size of its vehicle cabin is provided separately, the vehicle information may be information that indicates only the vehicle type of the vehicle 10. The recipient information is information in which a package ID is associated with a user ID. Every time delivery of a package occurs, the recipient information is updated by the delivery company.

The controlling portion 303 is means that manages a control of the delivery management server 300. The controlling portion 303 is constituted by a processor such as a CPU, for example. The controlling portion 303 includes a delivery management portion 3031 and a deliverability determination portion 3032 as functional modules. The functional modules may be implemented by causing a processor such as the CPU to perform programs stored in storage means such as a ROM (they are not illustrated herein).

The delivery management portion 3031 is means that receives a request from the portable terminal 200 and requests the key management server 400 to issue authentication information to unlock the vehicle 10. Upon receipt of information about a package to be delivered from the portable terminal 200, the delivery management portion 3031 specifies the vehicle 10 as a delivery destination based on recipient information and vehicle information stored in the storage portion 302 and requests the key management server 400 to issue terminal authentication information to lock and unlock the vehicle 10. Further, the delivery management portion 3031 transfers the terminal authentication information issued by the key management server 400 to the portable terminal 200. Note that the issue request of the terminal authentication information is performed only when the deliverability determination portion 3032 (described later) determines that the package is deliverable to the vehicle 10.

The deliverability determination portion 3032 determines whether or not the package to be delivered is storable in its corresponding vehicle 10 (a vehicle under the control of the recipient). Based on vehicle information corresponding to the vehicle 10 specified by the delivery management portion 3031 and package information corresponding to the package to be delivered to the vehicle 10, the deliverability determination portion 3032 determines whether or not the package is storable in the vehicle cabin of the vehicle 10. For example, the deliverability determination portion 3032 determines whether or not a cube with a size specified by a vehicle cabin size can contain a cube with a size specified by a package size. As a result of this determination, when the cube with the size specified by the vehicle cabin size can contain the cube with the size specified by the package size, the deliverability determination portion 3032 can determine that the package is storable in the vehicle 10, and if not, the deliverability determination portion 3032 can determine that the package is not storable in the vehicle 10.

Next will be described the key management server 400. The key management server 400 is a device configured to issue terminal authentication information to be used by the portable terminal 200 and device authentication information to be used by the locking/unlocking device 100, in response to a request from the delivery management server 300. The key management server 400 is constituted by a communication portion 401, a controlling portion 402, and a storage portion 403.

The communication portion 401 is a communication interface configured to perform network connection similar to the communication portion 301.

The controlling portion 402 is means that manages a control of the key management server 400. The controlling portion 402 is constituted by a CPU, for example. The controlling portion 402 includes a key issue portion 4021 as a functional module. The functional module may be implemented by causing a CPU to perform a program stored in storage means such as a ROM (they are not illustrated herein).

The key issue portion 4021 issues terminal authentication information and device authentication information in response to a request from the delivery management server 300. As described above, the terminal authentication information is authentication information for the portable terminal 200 to lock and unlock the vehicle 10 via the locking/unlocking device 100. Further, the device authentication information is authentication information paired with the terminal authentication information.

As the terminal authentication information and the device authentication information, terminal authentication information and device authentication information stored in advance may be acquired, or terminal authentication information and device authentication information may be generated dynamically. For example, authentication information that is effective only during a predetermined time zone, authentication information with a designated number of times of use, authentication information usable only by a predetermined portable terminal 200, and the like can be generated. Note that, in a case where the vehicle 10 includes a plurality of regions, e.g., a vehicle cabin and a trunk, that can be independently locked and unlocked, authentication information that can lock and unlock only any one of the regions may be generated.

The storage portion 403 is means in which information is stored and is constituted by a storage medium such as a RAM, a magnetic disk, or a flash memory. Device authentication information corresponding to the locking/unlocking device 100, terminal authentication information paired with the device authentication information, and various data to generate these pieces of authentication information are stored in the storage portion 403.

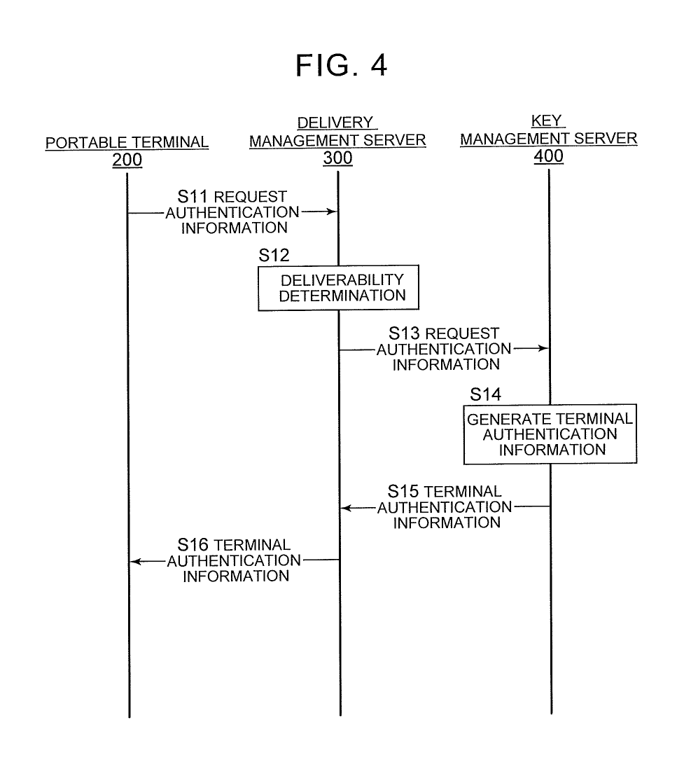

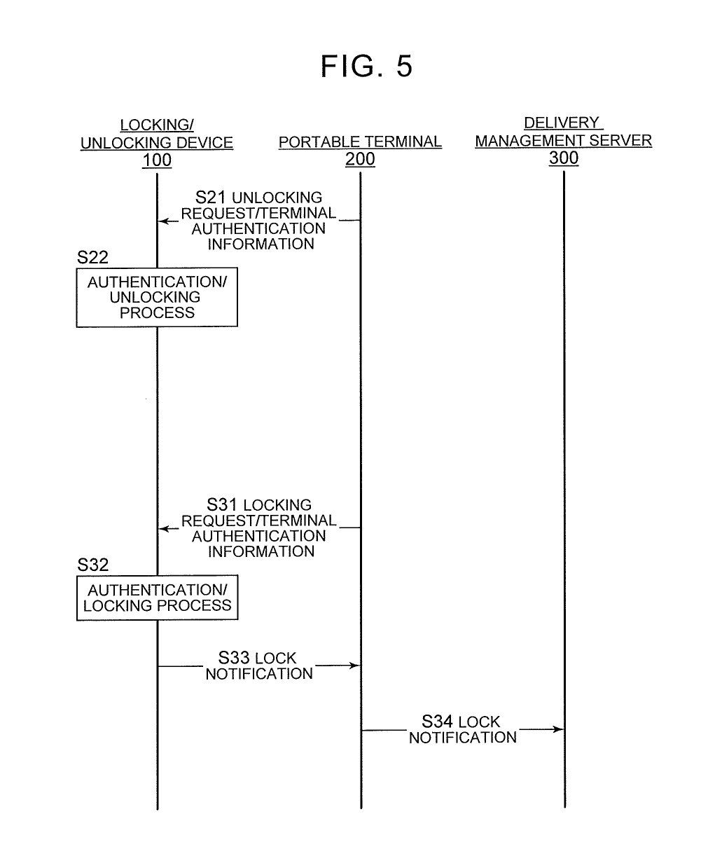

Next will be described processes performed by the constituents described above. The processes can be divided into a phase (a first phase) in which the portable terminal 200 acquires terminal authentication information and a phase (a second phase) in which the portable terminal 200 accesses the locking/unlocking device 100 by use of the acquired terminal authentication information so as to lock and unlock the vehicle. FIG. 4 is a view illustrating a data flow in the first phase, and FIG. 5 is a view illustrating a data flow in the second phase.

The first phase will be described with reference to FIG. 4. Processes of steps S11 to S16 are performed in response to an issue request of terminal authentication information from the portable terminal 200. First, in step S11, the portable terminal 200 requests the delivery management server 300 to issue terminal authentication information. In step S11, information to identify the portable terminal 200 and a package ID (e.g., a slip number) to uniquely identify a package to be delivered are transmitted at the same time as an authentication information request.

In step S12, the delivery management server 300 specifies the vehicle 10 as a delivery destination and determines whether the package to be delivered is deliverable or not. In step S12, the delivery management portion 3031 refers to the recipient information and the vehicle information stored in the storage portion 302 and specifies the vehicle 10 as the delivery destination based on these pieces of information. Further, the deliverability determination portion 3032 refers to the package information and the vehicle information stored in the storage portion 302 and determines whether or not the package is storable in the vehicle 10, based on a package size and a vehicle cabin size of the vehicle 10.

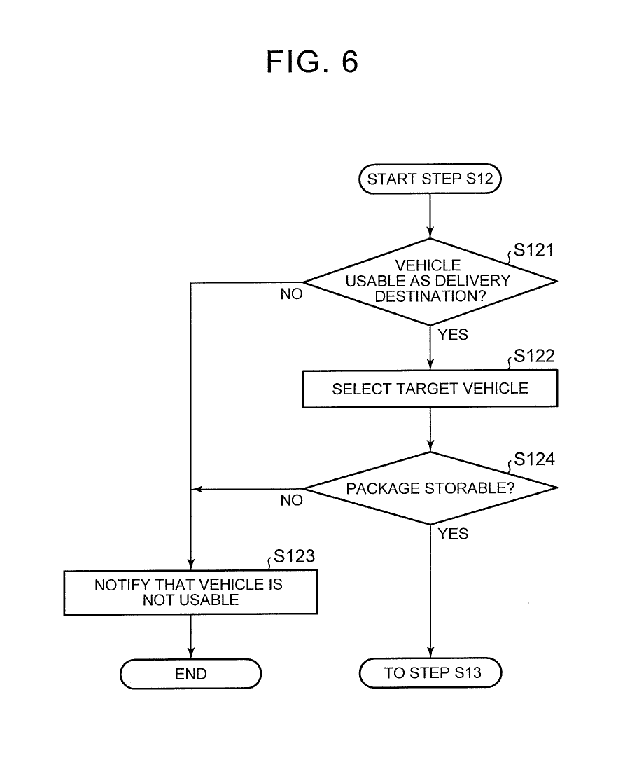

FIG. 6 is a view illustrating the process in step S12 more specifically. First, in step S121, the delivery management portion 3031 determines whether or not the vehicle 10 is usable as the delivery destination of the package, based on an identifier of the package included in the authentication information request and information stored in the storage portion 302 in advance. As a result of the determination, in a case where the vehicle 10 is usable, its corresponding vehicle 10 is selected (step S122), and the process proceeds to step S124.

In the meantime, in a case where the vehicle 10 is not usable as the delivery destination of the package (in a case where the vehicle 10 is not permitted to be used or there is no information about the vehicle 10), a notification indicating that the vehicle 10 is not usable as the delivery destination is generated and transmitted to the portable terminal 200 (step S123). In this case, the process illustrated in FIG. 4 is finished. Note that, in a case where a plurality of vehicles 10 is usable as the delivery destination of the package, the process can proceed by selecting any of the vehicles. The selection of a vehicle may be performed by the delivery carrier or may be automatically performed by a device. Further, the delivery management portion 3031 may select a vehicle by referring to information about the package. For example, a vehicle having a trunk size corresponding to the size of the package may be selected automatically.

When the vehicle 10 is selected, the deliverability determination portion 3032 determines, in step S124, whether or not the package is storable in the vehicle cabin of the vehicle 10, based on the stored package information and the stored vehicle information. Note that, in a case where a plurality of packages is to be delivered, the deliverability determination portion 3032 determines whether all the packages are storable or not. As a result of the determination, when the package is storable, the process proceeds to step S13. When the package is not storable, the process proceeds to step S123, and a notification indicating that the vehicle 10 is not usable as the delivery destination is generated and transmitted to the portable terminal 200 (step S123), as described earlier. In this case, the process illustrated in FIG. 4 is finished. Note that, in step S123, a reason why the vehicle 10 is not usable may be shown.

Now back to FIG. 4, the following continues the description. In step S13, the delivery management portion 3031 adds an identifier of the vehicle to the authentication information request and transmits them to the key management server 400.

In step S14, the key issue portion 4021 generates (or acquires) terminal authentication information inherent to the portable terminal 200 and the vehicle 10 (the locking/unlocking device 100 provided in the vehicle 10).

Then, in step S15, the terminal authentication information thus generated is transmitted to the delivery management server 300 (step S15). Further, the delivery management server 300 transfers the terminal authentication information to the portable terminal 200 (step S16). Hereby, an operation to unlock the vehicle 10 is performable on the portable terminal 200. Note that, in steps S15 and S16, it is preferable that information to identify the vehicle 10 to be used as the delivery destination be further transmitted as information associated with the terminal authentication information. For example, by transmitting information about a vehicle type or a number plate, positional information of the vehicle 10, and the like at the same time, the delivery carrier can easily find a target vehicle.

Note that, in this example, the terminal authentication information is transferred via the delivery management server 300, but the terminal authentication information may be directly transmitted to the portable terminal 200 from the key management server 400. Further, in this example, the device authentication information is issued by the key management server 400 and stored in the locking/unlocking device 100 in advance, but the device authentication information may be issued by the key management server 400 at the same timing as step S14 and transferred to the locking/unlocking device 100 via the delivery management server 300.

Note that the processes of steps S11 to S16 are preparation processes for performing locking and unlocking, so it is preferable to perform the processes in advance. For example, the processes may be performed in a preliminary stage of delivery.

The second phase will be described with reference to FIG. 5. Steps S21 to S22 are processes to unlock the vehicle 10 by use of the portable terminal 200. When the user (that is, the delivery carrier) of the portable terminal 200 performs an operation to unlock the vehicle 10 via the input/output portion, a link by the BLE is established between the portable terminal 200 and the locking/unlocking device 100, and in step S21, the portable terminal 200 transmits an unlocking request and the terminal authentication information to the locking/unlocking device 100.

In step S22, the authentication portion 1022 provided in the locking/unlocking device 100 verifies the terminal authentication information transmitted from the portable terminal 200 with the device authentication information stored in advance and performs an authentication process. When the authentication is successful, the key controlling portion 1023 unlocks the door of the vehicle 10.

Steps S31 to S34 are processes to lock the vehicle 10 by use of the portable terminal 200. When the user of the portable terminal 200 performs an operation to lock the vehicle 10 via the input/output portion (e.g., a touch panel screen), the portable terminal 200 transmits a locking request and the terminal authentication information to the locking/unlocking device 100 in step S31.

In step S32, the authentication portion 1022 provided in the locking/unlocking device 100 verifies the terminal authentication information transmitted from the portable terminal 200 with the device authentication information stored in advance and performs an authentication process. When the authentication is successful, the key controlling portion 1023 locks the door of the vehicle 10.

Further, after the locking is performed, the communication processing portion 1031 provided in the locking/unlocking device 100 transmits, to the portable terminal 200, a notification (a lock notification) indicating that the locking has been completed (step S33). Hereby, the notification indicating that the locking has been completed is output on the touch panel screen of the portable terminal 200. Note that, in a case where the terminal authentication information is a one-time key, the one-time key may be invalidated at the timing of step S33. Finally, the portable terminal 200 transmits the lock notification to the delivery management server 300 (step S34). Note that the delivery management server 300 may transmit a message indicative of completion of delivery to a terminal related to the recipient (e.g., a portable terminal or the like possessed by the recipient).

In the above embodiment, before a package is delivered to a vehicle, it can be found in advance whether or not the package is storable in the vehicle.

Note that, in the example of FIG. 6, in a case where it is determined that the vehicle 10 is not usable, the notification is transmitted only to the portable terminal 200, but a similar notification may be transmitted to a portable terminal (not shown) possessed by the recipient. This can urge the recipient to change a delivery time zone, a receipt place, or the like. Further, in the example of FIG. 6, in a case where it is determined that the vehicle 10 is not usable, only the notification is performed, but a measure to deliver the package may be taken. For example, in a case where a plurality of target packages is to be delivered and some of the packages are storable, a delivery schedule may be changed to deliver the packages separately.

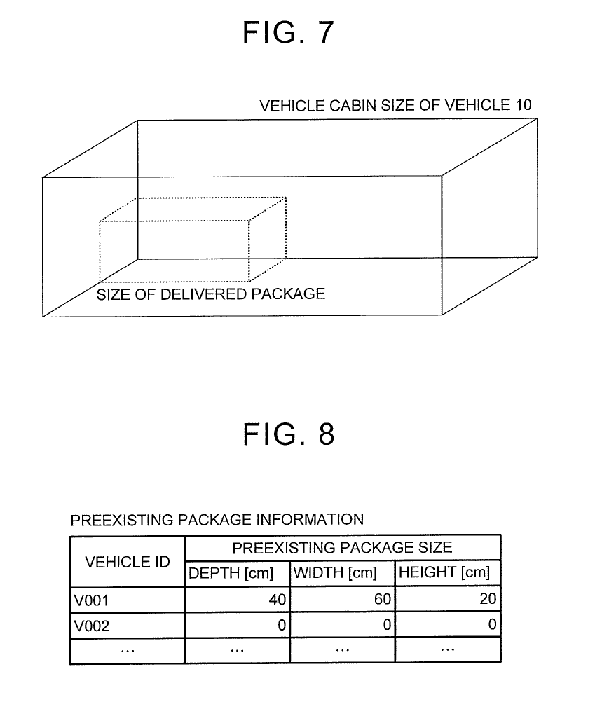

In the first embodiment, it is determined whether the package is storable or not, on the premise that the vehicle cabin size defined in the vehicle information is secured. However, there is such a case that packages are delivered several times on the same day, personal stuff of the recipient is put in the vehicle cabin, or a usable space in the vehicle cabin is narrower than expected. For example, as illustrated in FIG. 7, in a case where a delivered package has been already stored, a usable space is narrowed, so that a new package may not be storable. A second embodiment deals with this problem, and in the second embodiment, a space inside the vehicle cabin is sensed, and information about a package (hereinafter referred to as a preexisting package) that has been already put in the vehicle cabin is generated and used. In this case, the vehicle 10 may transmit the information about the preexisting package to the delivery management server 300, and the information about a size of a vehicle cabin of the vehicle may be updated thereby.

In the second embodiment, the vehicle 10 further includes means (not shown) that acquires a size of the preexisting package put in the vehicle cabin. For example, the size of the preexisting package may be found by estimating a volume of an object that has been already put in the vehicle cabin, based on a result of sensing performed by a sensor. The volume of the object that has been already put in the vehicle cabin may be acquired by use of a plurality of distance sensors or the like provided in the vehicle cabin or may be estimated such that a distance image inside the vehicle cabin is acquired and the volume is estimated based on the distance image thus acquired.

The vehicle 10 transmits information about the size of the preexisting package put in the vehicle cabin to the delivery management server 300 at a predetermined cycle. The transmission may be performed at a timing when it can be estimated that the number of packages in the vehicle cabin is increased or decreased. For example, the transmission may be performed every time the door or the gate of the vehicle 10 is closed.

In the second embodiment, information (preexisting package information) about the size of the preexisting package is stored in the storage portion 302. Further, when the delivery management server 300 acquires information from the vehicle 10, the delivery management server 300 updates the preexisting package information thus stored. FIG. 8 is an example of the preexisting package information. Further, in step S124, whether a package to be newly delivered is storable or not is determined in consideration of the size of the preexisting package.

As such, in the second embodiment, even in a case where a package has been already stored in the vehicle cabin of the vehicle 10, it can be determined whether or not a new package is storable.

Note that, in the example of FIG. 8, the preexisting package information is illustrated as a single record, but in a case where it is estimated that a plurality of packages is stored in the vehicle cabin, a plurality of records may be generated for the packages. Further, whether a package to be newly delivered is storable or not may be determined in consideration of a plurality of preexisting packages. Further, in step S124, it may be determined whether or not a new package becomes storable if a place or a direction of the preexisting package is changed.

In the second embodiment, the size of the preexisting package is detected based on the result of sensing the vehicle cabin, but in a case where personal stuff is not put in the vehicle cabin, the size of the preexisting package can be acquired based on a package delivery history. A third embodiment is an embodiment in which the preexisting package is estimated based on the package delivery history on the premise that personal stuff is not put in the vehicle cabin. In this case, the vehicle 10 may transmit information about the preexisting package to the delivery management server 300, and the information about a size of a vehicle cabin of the vehicle may be updated thereby.

In the third embodiment, at a timing when a package is delivered to the vehicle 10 (e.g., at a timing when the locking is notified to the delivery management server 300 in step S34), the delivery management server 300 estimates that the package is stored and updates the preexisting package information (corresponding to an example of “history” of the disclosure) illustrated in FIG. 8. In the embodiment, storability can be determined in consideration of the influence of the preexisting package without providing means that senses the vehicle cabin.

Note that, in the third embodiment, since sensing in the vehicle cabin is not performed, the delivery management server 300 cannot acquire information that the package in the vehicle cabin has been taken out. In view of this, information indicating that the package has been taken out (an example of “receipt information” of the disclosure) may be acquired from a terminal (hereinafter referred to as a recipient terminal) possessed by the recipient. For example, at the time when the recipient takes out the package from the vehicle 10, the recipient terminal acquires a package ID (e.g., an identification bar code attached to the package may be read by a camera or a slip number may be recognized by the camera) and transmits it to the delivery management server 300. Further, the delivery management server 300 recognizes that a corresponding package has been taken out and updates the preexisting package information. Hereby, the delivery management server 300 can acquire information that the package has been taken out from the vehicle 10.

The above embodiments are just examples, and the disclosure can be carried out with various modifications within a range that does not deviate from the gist of the disclosure. For example, in the descriptions of the embodiments, a vehicle cabin or a trunk of an automobile is exemplified as a lockable and unlockable region where a package is storable. However, the disclosure is not limited to this. The disclosure is applicable to facilities or storage devices other than the automobile, provided that they have a region that can be locked and unlocked by use of a portable terminal.

Further, in the descriptions of the embodiments, information indicative of depth, width, and height is used as sizes of a package and a vehicle cabin, but the sizes of the package and the vehicle cabin may be indicated by other information. Further, whether a package is storable or not may be determined by a well-known method other than the method exemplified above.

In the above embodiments, an example in which a size of the preexisting package is detected based on a result of sensing a vehicle cabin and an example in which a preexisting package is estimated based on a package delivery history are described. On the other hand, the information about a size of a vehicle cabin may be acquired by detecting a size of a vehicle cabin based on the result of sensing the vehicle cabin or may be acquired by estimating a size of available space of the vehicle based on the package delivery history. The vehicle 10 may transmit the acquired information to the delivery management server 300 and the information about a size of a vehicle cabin of the vehicle may be updated thereby.

Further, in the descriptions of the embodiments, deliverability is determined in response to a request from a delivery carrier who delivers a package, but deliverability may be determined at a different timing from this. For example, the process illustrated in FIG. 6 may be performed at a timing when delivery of a package is requested or at a timing before the package arrives at a delivery base, and in a case where the package is not storable (a negative determination is made in step S124), the recipient may be notified that the package is not storable. That is, in a case where the vehicle is designated as a delivery destination of the package, but the package is not storable, the recipient may be notified of this situation. Hereby, the recipient can be urged to change a delivery method or clean up the vehicle cabin.

What is claimed is:

1. A server device configured to determine whether or not a package is able to be stored in a predetermined region of a storage device, the predetermined region being lockable and unlockable, the server device comprising a processor configured to:
acquire storage device information that is information about a size of the predetermined region in the storage device;
acquire package information that is information about a size of the package to be stored in the predetermined region; and
perform a determination to determine whether or not the package is able to be stored in the predetermined region, based on the package information and the storage device information.

2. The server device according to claim 1, wherein the processor is configured to, when the processor determines that the package is able to be stored in the predetermined region, transmit key information to a portable terminal possessed by a user who intends to store the package in the predetermined region, the key information being used for unlocking the predetermined region.

3. The server device according to claim 2, wherein the processor is configured to perform notification to a predetermined device when the processor determines that the package is not able to be stored in the predetermined region.

4. The server device according to according to claim 1, wherein the processor is configured to acquire, as the storage device information from the storage device, a result of sensing the size of the predetermined region.

5. The server device according to according to claim 1, wherein the processor is configured to:
acquire a history about package storage of the storage device; and
perform the determination further based on the history.

6. The server device according to claim 5, wherein the processor is configured to:
acquire receipt information from a recipient, the receipt information indicating that the recipient has taken out the package from the storage device; and
perform the determination further based on the receipt information.

7. The server device according to according to claim 1, wherein:
the storage device is a vehicle; and
the processor is configured to acquire the storage device information defined for each vehicle type.

8. A delivery system comprising:
a storage device configured to be locked and unlocked based on authentication information acquired from a portable terminal; and
a server device configured to determine whether or not a package is able to be stored in a predetermined region of the storage device, wherein:
the storage device includes a transmitter configured to transmit storage device information that is information about a size of the predetermined region in the storage device;
the server device includes a receiver configured to acquire the storage device information, and a processor; and
the processor is configured to
acquire package information that is information about a size of the package to be stored in the predetermined region, and
determine whether or not the package is able to be stored in the predetermined region, based on the package information and the storage device information.
